(19) United States
(12) Patent Application Publication
(10) Pub. No.: US 2010/0116429 A1
(43) Pub. Date: May 13, 2010

(54) METHOD FOR LAYERED GLASS MICRO-REACTOR FABRICATION

(76) Inventors: George Edward Berkey, Pine City, NY (US); Cameron Wayne Tanner, Horseheads, NY (US); Robert Stephen Wagner, Corning, NY (US)

Correspondence Address: CORNING INCORPORATED, SP-TI-3-1, CORNING, NY, 14831, US

(21) Appl. No.: 12/267,893

(22) Filed: Nov. 10, 2008

(51) Int. Cl. B32B 38/10

(52) U.S. Cl. 156/249; 156/257

(57) ABSTRACT

Embodiments of a method of fabricating a micro-reactor comprise providing a base layer comprising glass or glass ceramic material, providing a plurality of layers comprising glass or glass ceramic material, adhering the plurality of layers together to form a multilayer substrate, cutting a serpentine pattern of channels into the multilayer substrate, forming a plurality of serpentine layers by separating the serpentine patterned multilayer substrate, and forming a micro-reactor by bonding together the base layer, at least one serpentine layer, and one or more additional layers.

### BACKGROUND

The present disclosure is generally directed to micro-reactors and, more specifically, to methods of fabricating micro-reactors.

### SUMMARY

In the chemical and pharmaceutical industries, the need for the processing of small quantities of high value materials is continually increasing. Conventional large processing facilities do not lend themselves well for the manufacture of specialized high value small volume products requiring a higher degree of process control (temperature, pressure, flow rates, mixing, etc.). Hence, the present inventors have recognized a need for micro-reactors capable of processing small batches of materials in a more continuous and controlled fashion.

Micro-reactors are commonly referred to as microstructured reactors, microchannel reactors, or microfluidic devices. Regardless of the particular nomenclature utilized, the micro-reactor is a device in which a sample can be confined and subject to processing. The sample can be moving or static, although it is typically a moving sample. In some cases, the processing involves the analysis of chemical reactions. In others, the processing is executed as part of a manufacturing process utilizing two distinct reactants. In still others, a moving or static target sample is confined in a micro-reactor as heat is exchanged between the sample and an associated heat exchange fluid. In any case, the dimensions of the confined spaces may be on the order of about 1 mm. Microchannels are the most typical form of such confinement and the micro-reactor is usually a continuous flow reactor, as opposed to a batch reactor. The internal dimensions of the microchannels provide considerable improvement in mass and heat transfer rates. Micro-reactors that employ microchannels offer many advantages over conventional scale reactors, including vast improvements in energy efficiency, reaction speed, reaction yield, safety, reliability, scalability, etc.

Many materials have been examined for use in a micro-reactor. The material properties of interest include: high corrosion resistance (chemical durability), flexibility to operate at high and low temperatures, high pressure operation, etc. Glass offers many advantages over metals, ceramics and non-metals, but may be more difficult to shape and create 3D structures of interest. Also, some glass materials may suffer shortcomings. For example, some glass materials may be limited to temperatures of approximately 450° C. Also, some glasses are prone to devitrification

As a result, the present inventors have recognized a continuing need for improved systems and methods for manufacturing micro-reactors, especially complex 3D micro-reactor structures having a functional micro-reactor geometry suitable for the pharmaceutical and chemical industries.

According to one embodiment of the present disclosure, a method of forming a micro-reactor is provided. The method comprises providing a base layer comprising glass or glass ceramic material, providing a plurality of layers comprising glass or glass ceramic material, adhering the plurality of layers together to form a multilayer substrate, cutting a serpentine pattern of channels into the multilayer substrate, forming a plurality of serpentine layers by separating the serpentine patterned multilayer substrate, and forming a micro-reactor by bonding together the base layer, at least one serpentine layer, and one or more additional layers.

According to yet another embodiment of the present disclosure, a method of forming a micro-reactor is provided. The method comprises the steps of providing a base layer comprising glass or glass ceramic material, and at least one substrate layer comprising glass or glass ceramic material, forming a serpentine layer by cutting a serpentine pattern of channels and a mixing region pattern in the at least one substrate layer by waterjet cutting, laser cutting or combinations thereof, depositing a plurality of extensions onto a top surface of the at least one base layer via laser induced deposition, aligning the serpentine layer between the base layer and one or more additional layers by inserting the plurality of extensions at least partially into the mixing region pattern of the serpentine layer and a mixing region pattern of the one or more additional layers, and forming a micro-reactor by bonding the at least one bottom layer, the at least one serpentine layer, and the one or more additional layers.

These and additional features provided by the embodiments of the present disclosure will be more fully understood in view of the following detailed description, in conjunction with the drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a flow chart illustrating a method of forming a micro-reactor according to one embodiment of the present disclosure;

FIG. 2 is an exploded view of the layers of the micro-reactor in accordance with the present disclosure;

FIG. 3 is a top view of the serpentine layer of the micro-reactor in accordance with the present disclosure;

FIG. 4 is a partial view of the base layer and the serpentine layer of the micro-reactor, wherein the base layer comprises posts extending through the mixing region of the serpentine layer in accordance with the present disclosure; and

FIG. 5 is a partial perspective view of the base layer of the micro-reactor in accordance with the present disclosure.

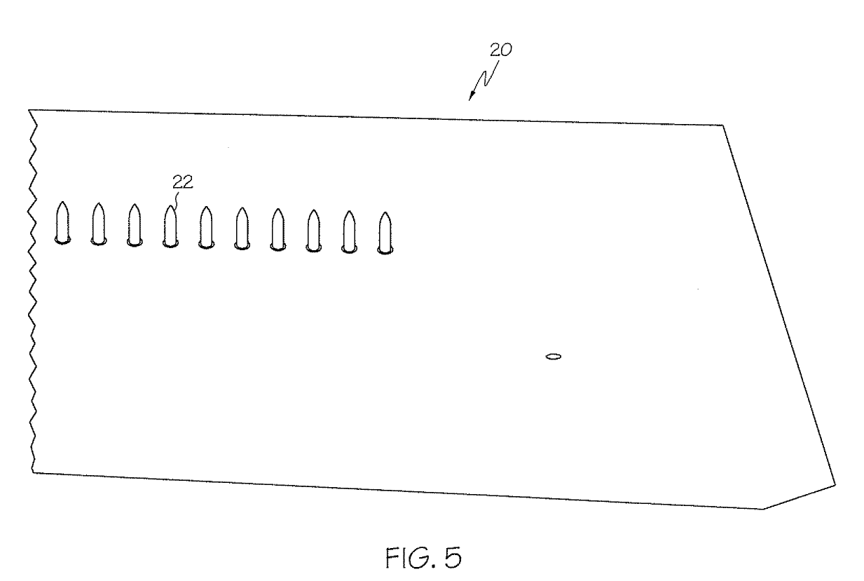

The embodiments set forth in the drawings are illustrative in nature and not intended to be limiting of the invention defined by the claims. Moreover, individual features of the drawings and invention will be more fully apparent and understood in view of the detailed description.

### DETAILED DESCRIPTION

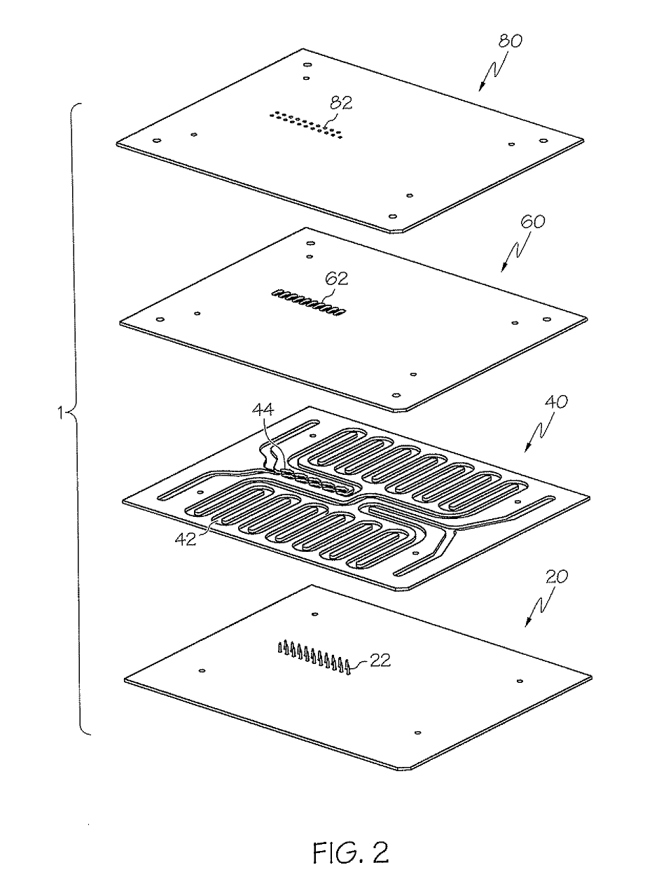

Referring to the embodiment of FIG. 2, a micro-reactor 1 may comprise a base layer 20, a serpentine layer 40, or other additional layers, such as a mixer layer 60, a top layer 80, or combinations thereof. Additional layers above, below, or between are contemplated herein. As shown, the base layer 20, which may in one exemplary embodiment constitute the bottom layer, comprises a plurality of extensions 22. For alignment of the layers, the extensions 22 may extend through the mixing region 44 of the serpentine layer 40, and the mixing regions 62, and 82 of the mixer layer 60 and top layer 80, respectively. Additionally, the extensions 22 may also create turbulence for the reacting fluids passing through the mixing regions of the micro-reactor 1.

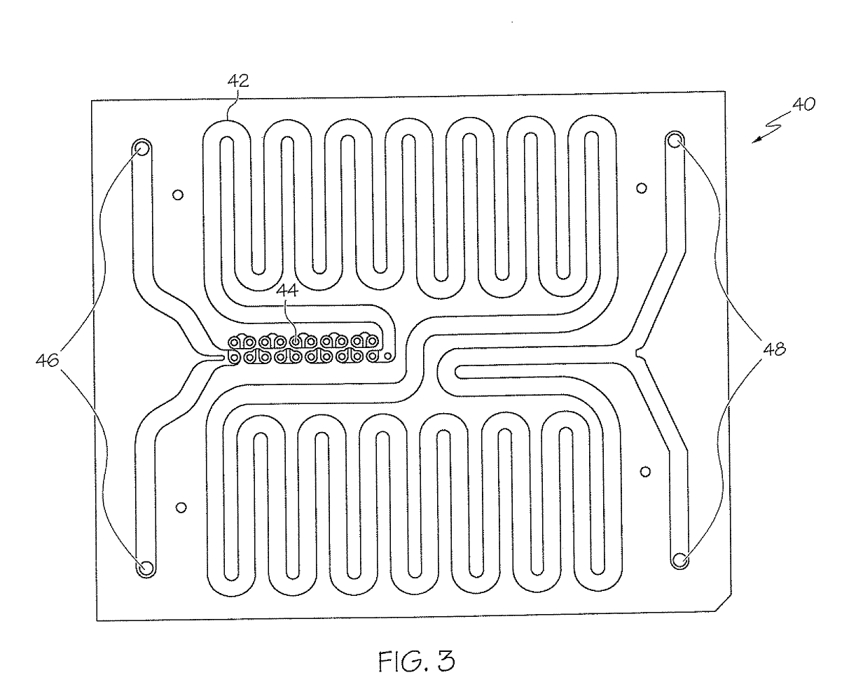

Referring to FIG. 3, the serpentine layer 40 may comprise a circuitous pattern of channels 42 and a mixing region pattern 44. As shown in the embodiment of FIG. 3, one or more fluid reactants may be added via the inlets 46 of the serpentine layer 40. The fluid reactants are combined in the mixing region 44, and are allowed to mix while moving through the channels of the serpentine pattern 42. The retention time inside the micro-reactor 1 may be controlled by varying the length of the serpentine pattern 42, or by varying the channel thickness of the serpentine pattern 42. Further as shown in FIG. 3, the serpentine layer 40 may comprise one or more outlets 48 for the fluid mixture to exit the micro-reactor 1.

Referring to FIG. 2, the micro-reactor 1 may comprise one or more additional layers disposed above the serpentine layer 40. For example, the mixer layer 60 may comprise a mixing region 62, wherein the extensions 22 of the base layer 20 may extend through. In the top layer 80, the extensions 22 may extend through or only partially through the mixing region 82. In one embodiment, the mixing region 82 may act as a cap for extensions 22. The mixing region 82 is designed to create a highly turbulent zone to force the homogenous mixing of the constituent materials.

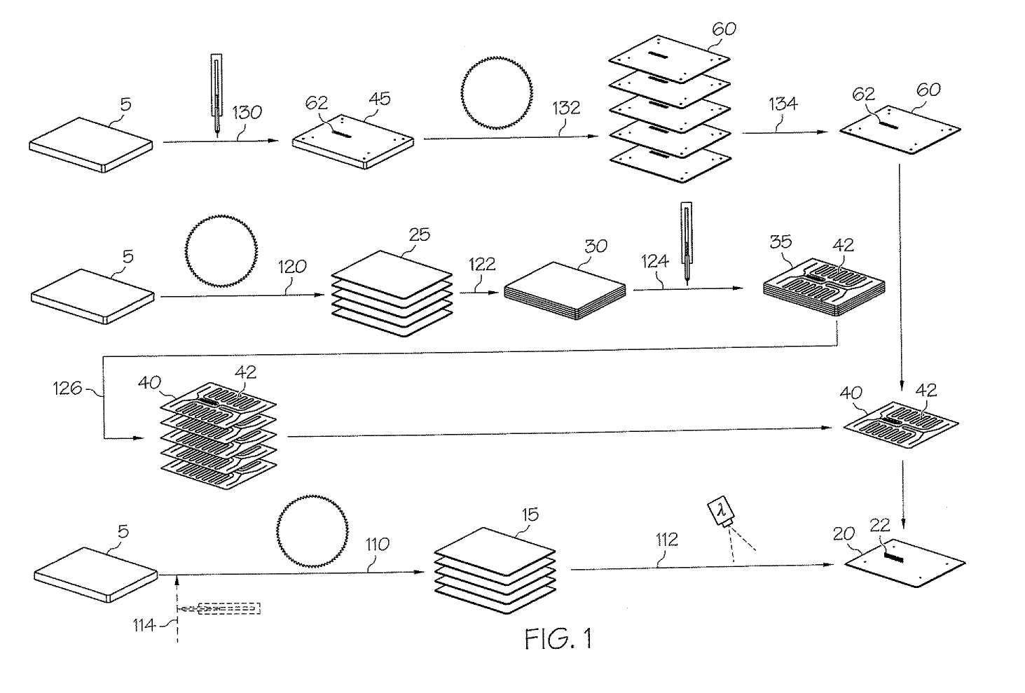

Before each of the layers 20, 40, 60, and 80 are aligned as shown in FIG. 2 and then bonded together, the layers are fabricated as shown below. Referring to FIG. 1, the base layer 10 may be produced by providing a bulk substrate 5. The bulk substrate 5 may comprise a glass or glass ceramic material, for example, a glass or glass ceramic material comprising silicon dioxide (SiO₂) and boric oxide (B₂O₃), a silica sheet or combinations thereof. One suitable commercial material is Vycor® produced by Corning Incorporated. Vycor® offers high chemical durability and inertness, and resists devitrification which makes for ease of frit-less sealing. In addition to Vycor®, many other glass and glass-ceramic materials will lend themselves to this approach. The stability of the glass permits frit-less sealing to be done in ordinary refractory lined furnaces. The high temperature nature of the glass permits device usage to approximately 1400° C. In addition, the Vycor® yields properties which allow for high differential temperature operation (i.e., moving quickly from heating to cooling without producing thermal shock).

Referring again to FIG. 1, the bulk substrate 5 is cut into a plurality of layers 12 as shown in step 110. The cutting operation may be achieved by any suitable cutting operation known to one of ordinary skill in the art, for example, cutting using a wire saw. Other cutting technologies familiar to one or ordinary skill in the art are contemplated herein. As illustrated in optional step 114, it is further contemplated to form patterns in the bulk substrate 5 via waterjet cutting or laser cutting prior to cutting the bulk substrate 5 to form the plurality of layers 12.

As shown in FIG. 1, after the plurality of base layers 15 are formed, one or more extensions 22 may be deposited onto a surface of each base layer 20. Although any structure for the extensions 22 is contemplated herein, the plurality of extensions 22 may comprise glass posts. Suitable glass materials include, but are not limited to, fused silica glass, fused quartz, glass ceramics, titanium silicate glass, etc. The deposition may utilize various suitable technologies familiar to one of ordinary skill in the art, for example, laser induced deposition as shown in step 112. In laser induced deposition, a laser beam of sufficient thermal energy heats a portion of feed material to a temperature at which it can be bonded to the base layer 20 in the form of extensions 22.

To produce the serpentine layer 40 according to the embodiment of FIG. 1, a bulk substrate 5 is sliced into a plurality of layers 25, for example, by cutting with a wire saw as shown in step 120. The plurality of layers 25 are then adhered together to form a multilayer substrate 30 as illustrated in step 122. The layers of the multilayer substrate 30 may be adhered using any suitable adhesive, such as glues, tapes, resins, etc. Then as shown in step 124, a serpentine pattern 42 of channels is cut into the multilayer substrate 30 using laser cutting or waterjet cutting. As shown in FIG. 1, serpentine pattern 42 may include a plurality of channels and a mixing region 44. After patterning, the serpentine patterned multilayer substrate 35 may be converted into a plurality of serpentine layers 40 by removing the adhesive. It is also contemplated that each of the plurality of layers 25, which were formed by slicing the bulk substrate 5, may be patterned individually via water jet cutting or laser cutting. However, individually patterning adds significantly more processing steps and processing time than adhering the sliced plurality of layers 25 to form the multilayer substrate 30 and then performing patterning once.

Referring again to FIG. 1, to produce additional layers, such as the top layer 80 or mixer layer 60, a bulk substrate 5 comprising the glass or glass ceramic material is patterned using laser cutting or waterjet cutting. As shown, the pattern 62 may be a mixing region as shown in FIG. 2. Subsequently, the patterned bulk substrate 45 is sliced into a plurality of patterned layers 60 to form the one or more additional layers (e.g. a mixer layer 60 as shown in FIG. 2).

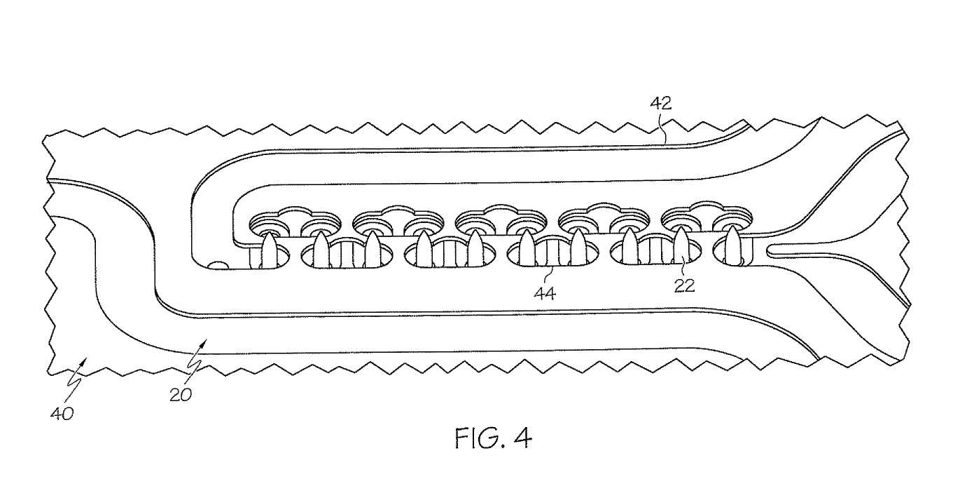

Referring to FIG. 2, the micro-reactor 1 is formed by bonding together the base layer 20, at least one serpentine layer 40, and one or more additional layers (e.g., mixer layer 60 or top layer 80). As shown in the embodiment of FIG. 4, the plurality of extensions 22 of the base layer 20 may extend through a mixing region pattern 44 of the serpentine layer 40. Referring to FIG. 2, the extensions 22 may also extend through a mixing region pattern 62 of the mixer layer 60 and at least partially into the mixing region pattern 82 of the top layer 80. The pattern 82 of the top layer 80 may act as a cap for the plurality of extensions 22 such that the extensions do not extend through all layers of the micro-reactor 1. By disposing the extensions 22 at least partially into or through the other layers 40, 60, and/or 80, the micro-reactor 1 is able to more easily align all layers. After alignment, the layers of the micro-reactor 1 are bonded via thermal bonding, chemical bonding or combinations thereof. Although various temperatures are contemplated for the thermal bonding, the thermal bonding, in one exemplary embodiment, may be performed at a temperature between about 1200° to about 1600° C.

For the purposes of describing and defining the present invention it is noted that the term “approximately” is utilized herein to represent the inherent degree of uncertainty that may be attributed to any quantitative comparison, value, measurement, or other representation. The term “approximately” is also utilized herein to represent the degree by which a quantitative representation may vary from a stated reference without resulting in a change in the basic function of the subject matter at issue.

The methods devices disclosed herein or the devices made by the methods disclosed herein may generally be useful in performing any process that involves mixing, separation, extraction, crystallization, precipitation, or otherwise processing fluids or mixtures of fluids, including multiphase mixtures of fluids—and including fluids or mixtures of fluids including multiphase mixtures of fluids that also contain solids—within a microstructure. The processing may include a physical process, a chemical reaction defined as a process that results in the interconversion of organic, inorganic, or both organic and inorganic species, a biochemical process, or any other form of processing. The following non-limiting list of reactions may be performed with the disclosed methods and/or devices: oxidation; reduction; substitution; elimination; addition; ligand exchange; metal exchange; and ion exchange. More specifically, reactions of any of the following non-limiting list may be performed with the disclosed methods and/or devices: polymerisation; alkylation; dealkylation; nitration; peroxidation; sulfoxidation; epoxidation; ammoxidation; hydrogenation; dehydrogenation; organometallic reactions; precious metal chemistry/homogeneous catalyst reactions; carbonylation; thiocarbonylation; alkoxylation; halogenation; dehydrohalogenation; dehalogenation; hydroformylation; carboxylation; decarboxylation; amination; arylation; peptide coupling; aldol condensation; cyclocondensation; dehydrocyclization; esterification; amidation; heterocyclic synthesis; dehydration; alcoholysis; hydrolysis; ammonolysis; etherification; enzymatic synthesis; ketalization; saponification; isomerisation; quaternization; formulation; phase transfer reactions; silylations; nitrile synthesis; phosphorylation; ozonolysis; azide chemistry; metathesis; hydrosilylation; coupling reactions; and enzymatic reactions.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A method of fabricating a micro-reactor comprising:
providing a base layer comprising glass or glass ceramic material;
providing a plurality of layers comprising glass or glass ceramic material;
adhering the plurality of layers together to form a multilayer substrate;
cutting a serpentine pattern of channels into the multilayer substrate;
forming a plurality of serpentine layers by separating the serpentine patterned multilayer substrate; and
forming a micro-reactor by bonding together the base layer, at least one serpentine layer, and one or more additional layers.

2. The method of claim 1 wherein the plurality of layers are provided by slicing a bulk substrate comprising glass or glass ceramic material into a plurality of layers;

3. The method of claim 1 further comprising forming the one or more additional layers by cutting a pattern comprising a mixing region into a bulk substrate comprising glass or glass ceramic material, and slicing the patterned bulk substrate into a plurality of patterned layers to form the one or more additional layers.

4. The method of claim 1 further comprising forming the base layer by slicing a bulk substrate comprising glass or glass ceramic material into a plurality of layers.

5. The method of claim 4 further comprising cutting a pattern into the bulk substrate prior to slicing the bulk substrate for base layer formation.

6. The method of claim 1 further comprising depositing a plurality of extensions onto a surface of the base layer.

7. The method of claim 6 wherein the plurality of extensions comprise glass posts.

8. The method of claim 6 wherein the deposition utilizes laser induced deposition.

9. The method of claim 6 wherein the plurality of extensions extend through a mixing region pattern of the at least one serpentine layer and a mixing region pattern of the one or more additional layers, thereby aligning the base layer, the at least one serpentine layer, and the one or more additional layers.

10. The method of claim 1 wherein the layers of the multilayer substrate are adhered using an adhesive.

11. The method of claim 1 wherein the slicing is achieved by using a wire saw.

12. The method of claim 1 wherein the one or more additional layers comprise a mixer layer and a top layer disposed over the mixer layer.

13. The method of claim 1 wherein the cutting occurs via waterjet cutting, laser cutting, or combinations thereof.

14. The method of claim 1 wherein the glass or glass ceramic material comprises silicon dioxide (SiO₂) and boric oxide (B₂O₃).

15. The method of claim 1 wherein the bonding is achieved via thermal bonding, chemical bonding or combinations thereof.

16. The method of claim 1 wherein the bonding is achieved via thermal bonding at a temperature between about 1200° to about 1600° C.

17. A method of fabricating a micro-reactor comprising:
providing a base layer comprising glass or glass ceramic material, and at least one substrate layer comprising glass or glass ceramic material;
forming a serpentine layer by cutting a serpentine pattern of channels and a mixing region pattern in the at least one substrate layer by waterjet cutting, laser cutting or combinations thereof;
depositing a plurality of extensions onto a top surface of the at least one base layer via laser induced deposition;
aligning the serpentine layer between the base layer and one or more additional layers by inserting the plurality of extensions at least partially into the mixing region pattern of the serpentine layer and a mixing region pattern of the one or more additional layers; and
forming a micro-reactor by bonding the at least one bottom layer, the at least one serpentine layer, and the one or more additional layers.

18. The method of claim 17 wherein the plurality of extensions comprise glass posts.

19. The method of claim 17 wherein the one or more additional layers comprise a mixer layer and a top layer disposed over the mixer layer.

20. The method of claim 17 wherein the glass or glass ceramic material comprises silicon dioxide (SiO₂) and boric oxide (B₂O₃).

21. The method of claim 17 wherein the bonding is achieved via thermal bonding, chemical bonding or combinations thereof.
